(19) United States
(12) Patent Application Publication
(10) Pub. No.: US 2024/0108532 A1
(43) Pub. Date: Apr. 4, 2024

(54) CRUTCHES, WALKING STICKS AND THE LIKE, AND ENHANCEMENT METHODS THEREFOR

(71) Applicant: Anthony Ippolito, Summit, NJ (US)

(72) Inventor: Anthony Ippolito, Summit, NJ (US)

(21) Appl. No.: 17/937,224

(22) Filed: Sep. 30, 2022

(51) Int. Cl. A61H 3/02

(52) U.S. Cl. CPC A61H 3/0277; A61H 2003/0211; A61H 2003/0283

(57) ABSTRACT

A crutch, or the like, that can handle ground conditions includes an elongate brace having a lower extension and an upper element. The upper element is adapted to engage a portion of the human anatomy. A device positioned at the lower extension includes a firm proximal member, and a firm distal member. The firm proximal member and the firm distal member are positioned below the upper end of the main body. Also included is an elongate flexible structure. This structure is adapted to engage the proximal member and the distal member, and allow them to angularly deflect relative to each other. An angular offset can then occur between the firm distal member and the main body. Also included is a base positioned below the distal member that has multiple feet.

### BACKGROUND OF THE INVENTION

### Field of the Invention

The present invention relates to crutches, walking sticks, and the like, that are adapted to handle ground conditions, and methods for enhancing them.

### Prior Art

Crutches, walking sticks or canes are used by persons that have suffered a foot or leg injury. The ends of these devices are placed on the ground and then lifted and moved forward as the person walks. Simple versions of these devices provide inadequate support for most persons. Basically, pressing against the ground at a single point involves only a small area and is unstable. This single point contact cannot easily deal with various types of ground surfaces.

More advanced crutches use a separate base that is able to shift angularly with respect to the main body of the crutch. In U.S. Pat. No. 4,947,882 a base with multiple feet can connect to a walking stick or crutch. The connection is by means of a ball and socket joint. A resilient cone positioned around the ball and socket can deform and will allow the base to articulate and adapt to ground irregularities.

The crutch in U.S. Pat. No. 2,426,594 has a lower section that slides telescopically into an upper section, where it will bear against an internal spring. This arrangement provides cushioning and shock absorbing.

See also U.S. Pat. Nos. 2,888,022; 3,486,515; 3,741,226; 7,344,320; 8,371,320; 8,464,737; and 8,607,809; as well as US Patent Application Pub. Nos. 2005/0205121; 2011/0094552; 2012/0067386; and 2017/0196322.

### SUMMARY OF THE INVENTION

In accordance with the illustrative embodiments demonstrating features and advantages of the present invention, there is provided a crutch, or the like, that is enhanced and adapted to handle ground conditions. The crutch, or the like, includes an elongate brace having a lower extension and an upper element adapted to engage a portion of the human anatomy. Also included is a device positioned at the lower extension. The device includes a firm proximal member, and a firm distal member. The crutch, or the like, also includes an elongate flexible structure adapted to engage the proximal member and the distal member, and allow them to angularly deflect relative to each other. Also included is a base positioned below the distal member that has multiple feet.

In accordance with another aspect of the invention, a method is provided that that can enhance a crutch, or the like, that has a main body with an upper and a lower end. The method employs a firm proximal member and a firm distal member. The method includes the step of positioning the firm proximal member and the firm distal member below the upper end of the main body. Also included is the step of allowing angular displacement between the firm proximal member and the firm distal member to produce an angular offset between the firm distal member and the main body.

In another disclosed embodiment, the main body of a crutch, or the like, has a tubular extension at its lower end. This embodiment has a pair of members arranged end to end with the proximal member able to slide telescopically into the tubular extension. The distal member engages a lower base that has multiple legs, each terminating in an elastomeric foot. This disclosed embodiment has a spring that encircles the distal and proximal members and the spring is lodged between the base and the tubular extension. This spring compresses when the proximal member slides into the tubular extension. The disclosed spring also allows the firm distal member to deflect relative to the tubular extension. The foregoing permits the base to adapt to ground irregularities.

Another disclosed embodiment, again has an end-to-end pair of firm members with the distal member bearing against a lower base and the proximal member sliding telescopically into a tubular extension at the lower end of the main body of the crutch, or the like. In this disclosed embodiment, the distal and proximal members are tubular. Also in this embodiment, a relatively narrow compression spring is threaded through the distal and proximal members. The lower end of the disclosed spring bears against the base and its upper end is attached to the inside of the tubular extension. This disclosed spring compresses when the proximal member slides into the tubular extension. The disclosed spring also allows the distal member to deflect relative to the tubular extension. The foregoing permits the base to adapt to ground irregularities.

It will be understood that some embodiments will have more than two firm members, in addition to the distal and proximal members. In other embodiments the distal and proximal members may have an intervening coupler that allows angular deflection between the two members. In other embodiments a flexible tubular sleeve will be mounted around or inside the two members to allow angular deflection of the members. In addition, for some embodiments the proximal member will abut the tubular extension without sliding into it.

Also, the term “crutch,” as used herein, includes a variety of walking aids, such as aids that engage a user's underarm or a user's forearm. Aids that clasp a forearm may, in some markets, be identified as walking sticks or canes. Overall, the aids that are herein considered to fall within the category of crutches or the like, are distinguished by having congruent functions that help a user to walk.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is a perspective view of a crutch in accordance with principles of the present invention;

FIG. 2 is a perspective view of the crutch of FIG. 1 showing deflection permitted by a device located between the base and the lower end of the main body of the crutch;

FIG. 3 is a detailed perspective view of the device of FIGS. 1 and 2 that is located between the base and the main body of the crutch;

FIG. 4 is an exploded, elevational view of the device of FIG. 3;

FIG. 5 is an exploded, elevational view of apparatus that is an alternate to that of FIG. 4;

FIG. 6 is an exploded, elevational view of apparatus that is an alternate to that of FIGS. 4 and 5; and

FIG. 7 is a top view of a base that is an alternative to those shown in the foregoing Figures.

### DETAILED DESCRIPTION

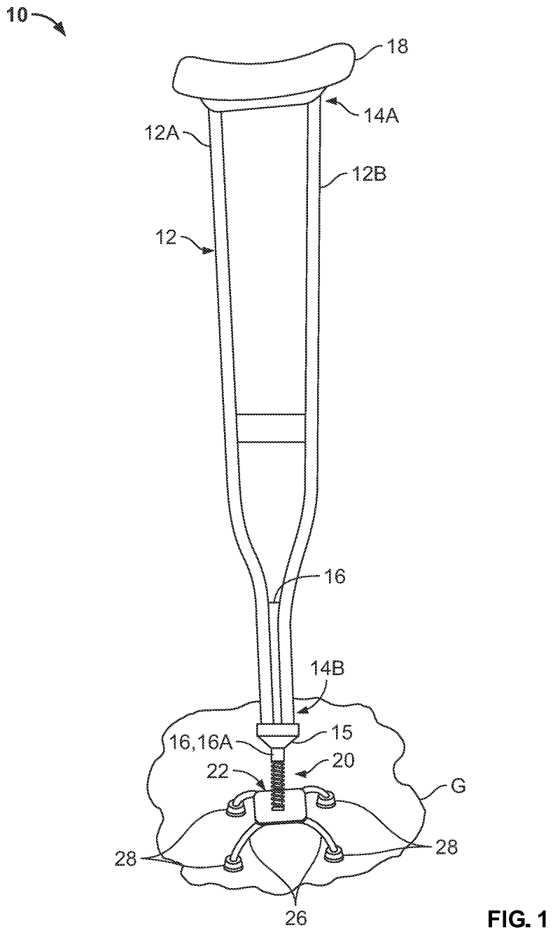

Referring to FIGS. 1-4, a crutch 10 has a main body 12 with an upper end 14A and a lower end 14B. Upper element 18 is shown as a cradle that can engage a portion of the human anatomy, in this case, an armpit. In some embodiments, the main body may have instead, an upper accessory that will clasp a user's forearm and may, in some markets, be referred to as a walking stick or cane. In fact mention herein of a “crutch” should be understood more broadly as a “crutch or the like,” and this will therefor connote a walking stick, a cane, etc.

Main body 12 of FIGS. 1-4 is shown as an elongate brace with upper segments 12A and 12B that descend and converge to embrace opposite sides of a lower extension 16. Segments 12A and 12B terminate at coupler 15, while extension 16 passes through coupler 15 to emerge on its distal side as lower interval 16A.

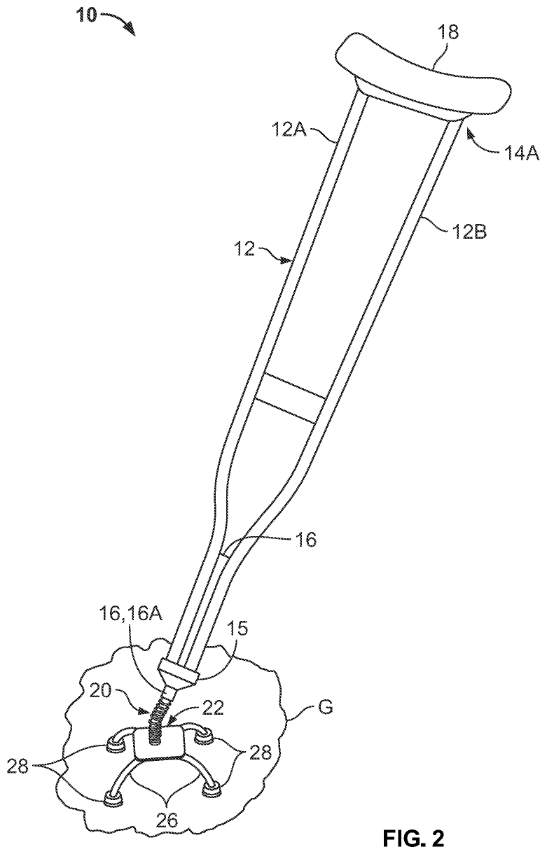

Device 20 is shown positioned between extension 16A and base 22. FIG. 2 reveals that device 20 is arranged to allow angular displacement between base 22 and main body 12. Base 22 is shown engaging the surface of ground G

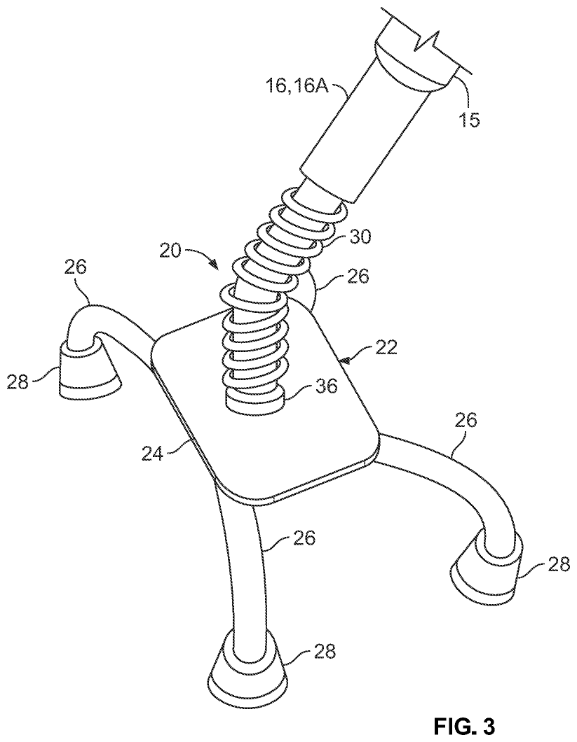

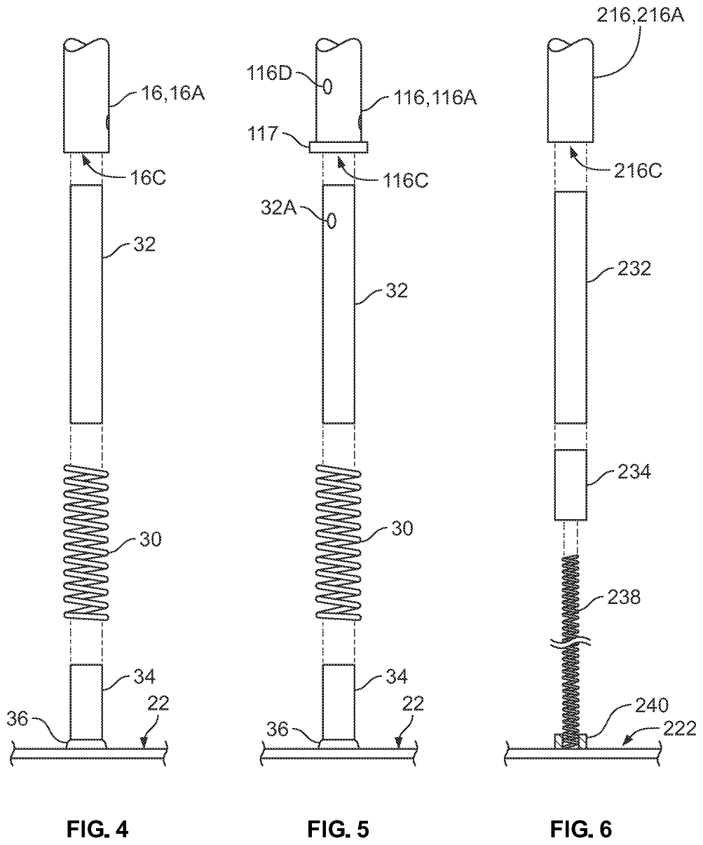

FIG. 3 shows that base 22 includes a plate 24 with four angularly spaced, diverging legs 26 attached to the underside of the plate. Each leg 26 terminates in a distal elastomeric foot 28. Referring to FIGS. 3 and 4, device 20 includes an elongate flexible structure 30. In this embodiment structure 30 is a compressible component, for example, a helical spring.

FIGS. 3 and 4 show that device 20 includes a firm proximal member 32 and a firm distal member 34. Members 32 and 34 are encircled by compressible component 30 in FIG. 3.

Members 32 and 34 are “firm” in that they maintain their basic shape even though they may distort somewhat under stress. Members 32 and 34 have a similar breadth and are designed to be positioned end-to-end. In this embodiment members 32 and 34 are tubular and can abut without either one penetrating the other. In other embodiments members 32 and 34 may be non-tubular or a continuous solid.

Extension 16, 16A is tubular and has an internal channel 16C. Proximal member 32 has a breadth that allows it to axially reciprocate relative to the main body of the crutch (body 12 of FIG. 1) by sliding telescopically into channel 16C. When member 32 moves in that direction, the clearance below extension 16, 16A diminishes. Basically, component 30 abuts against extension 16A and is compressed between the extension and base 22. This telescopic motion of proximal member 32 provides a cushioning effect that moderates impact forces on the user's armpit. A similar cushioning effect will be achieved for other walking sticks, canes and for crutches that clasp a user's forearm.

Since firm proximal member 32 is positioned inside extension 16, 16A, member 32 maintains its alignment with the extension. On the other hand, firm distal member 34 is not so constrained. Consequently, distal member 34 is free to angularly reciprocate relative to extension 16, 16A. This allows members 32 and 34 to relatively reciprocate toward positions that are aligned or are out of alignment.

This angular displacement is accommodated and managed by compressible component 30, which allows angular offsets but biases components 32 and 34 toward mutual alignment.

In this embodiment, distal member 34 is welded to plate 24 of base 22. Welding bead 36 shows this mode of attachment. Since distal element 34 is affixed in this fashion to base 22, the base and distal element will undergo similar angular displacement. Thus, the base 22 will be angularly displaced in sympathy with distal element 34.

To facilitate an understanding of the principles associated with the foregoing apparatus, its operation will be briefly described. Base 22 at the bottom of crutch 10 is shown undeflected in FIG. 1, possibly because no force is being applied through main body 12, or because any force through body 12 is balanced.

In a typical stride, the user will step forward while the base 22 remains in the same position on ground G. Due to this motion, main body 12 will tilt forward while base 22 deflects as shown in FIGS. 2 and 3.

Next, the user will lift main body 12 in order to move base 22 forward. The user may bring base 22 even with the user, but in this case, the user brings base 22 forward to place the base on ground G, ahead of the user. Due to this motion, main body 12 will tilt backward while base 22 will deflect (appearing as the mirror image of FIGS. 2 and 3).

The user will now stride forward, keeping base 22 at the same position on ground G. Due to this motion, main body 12 will tilt forward to return to the position shown in FIGS. 2 and 3.

The foregoing process now repeats as the user again lifts main body 12 in order to move base 22 forward.

As this process repeats, base 22 will engage successive locations on ground G, engaging the ground at an angle that will continuously change during a stride. The profiles of the successive ground locations can differ dramatically. However, the continuously changing angle of base 22 will adapt to the ever-changing profiles to stabilize crutch 10.

Some of the successive ground locations may be rough and irregular. However, legs 26 of base 22 will land at the spots that accommodate the hills and valleys of these rough and irregular ground locations. At the same time, the angle of base 22 will adapt to the changing terrain.

Referring to FIG. 5, elements 32, 30, 34, 36, and 22 are identical to the elements in FIGS. 1-4 bearing the same reference numbers. These corresponding elements in FIG. 5 also function the same as the elements of FIGS. 1-4 and will accommodate a crutch, or the like.

Extension 116, 116A corresponds to extension 16, 16A of FIGS. 1-4 and has the same reference numbers, but increased by 100. Extension 116A differs in that it has at its distal end, annular flange 117. Compressible component 30 will bear against flange 117.

Extension 116, 116A has, as before, an internal channel 116. Flange 117 has a central opening that allows free passage to channel 116.

Referring to FIG. 6, elements 216, 216A, 222, 232, and 234, are similar to elements in FIGS. 1-4 and they bear the same reference numbers but increased by 200. These corresponding elements in FIG. 6 also function in a manner similar to the corresponding elements of FIGS. 1-4, and accommodate a crutch, or the like. Members 232 and 234 are tubular in this embodiment. Extension 216, 216A has, as before, an internal channel 216C.

This embodiment has an elongate flexible structure 238 that is significantly narrower than structure 30 of FIGS. 1-4. This reduced breadth allows structure 238 to be slidably positioned inside members 232 and 234.

Annular ferrule 240 is welded atop base 222 and has a passage sized to receive the lower end of structure 238 and allow this structure to press against base 222. In this embodiment structure 238 is a compressible component, in this case, a helical spring. The lower end of compressible component 238 is secured in place by being welded to ferrule 240. In this embodiment, the upper end of compressible component 238 is affixed to the inside of internal channel 216C.

Proximal member 232 has a breadth that allows it to axially reciprocate relative to the main body of the crutch (body 12 of FIG. 1) by sliding telescopically into channel 216C. When member 232 moves in that direction, compressible member 238 is compressed between the extension 216, 216A and base 222.

This telescopic motion of proximal member 232 provides a cushioning effect that moderates impact forces on the user's armpit. A similar cushioning effect will be achieved for other walking sticks, canes and for crutches that clasp a user's forearm.

Since firm proximal member 232 is positioned inside extension 216, 216A, member 232 maintains its alignment with the extension. On the other hand, firm distal member 234 is not so constrained. Consequently, distal member 234 is free to angularly reciprocate relative to extension 216, 216A. This allows members 232 and 234 to relatively reciprocate toward positions that are aligned or are out of alignment.

This angular displacement is accommodated and managed by compressible component 238, which allows angular offsets but biases components 232 and 234 toward mutual alignment.

As previously described in connection with FIGS. 1-4, while striding forward, a user can lift and reposition base 222. As before, base 222 can adapt to varying surfaces that may be rough and irregular.

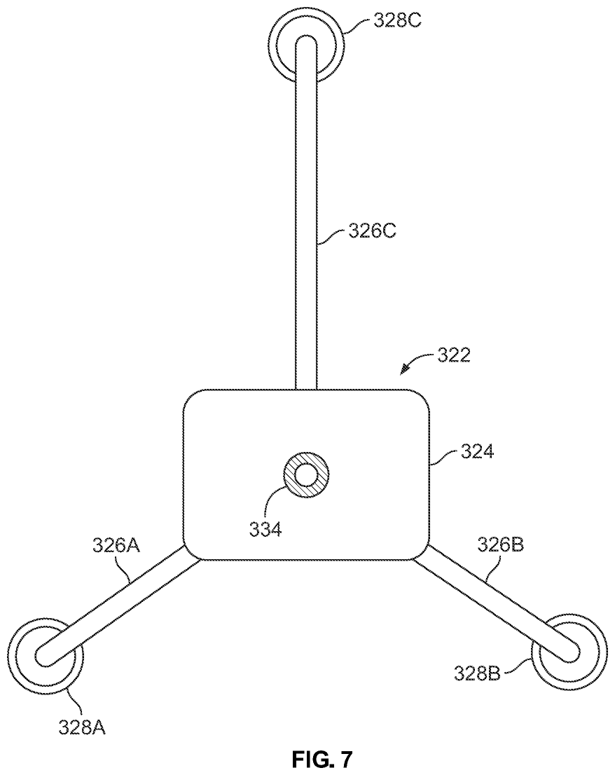

Referring to FIG. 7, elements 322, 324, 326A-326C, and 328A-328C, are similar to elements in FIG. 3 and bear corresponding reference numbers but increased by 300. These corresponding elements in FIG. 7 also function in a manner similar to the corresponding elements of FIGS. 1-4. Element 334 corresponds to element 34 in FIG. 4. Element 334 is welded to plate 324 and is therefore shown in cross section in FIG. 7.

The embodiment of FIG. 7 is distinct in that it has only three legs, namely left leg 326A, right leg 326B, and front leg 326C. This embodiment has a common, leg-to-leg angular spacing of about 120°. Also, legs 326A, 326B, and 326C each terminate in elastomeric feet 328A, 328B, and 328C, respectively.

The embodiment of FIG. 7 operates in a manner similar to the embodiment of FIG. 3, except for the issue of coordinating three legs instead of four. Basically, two of the legs of FIG. 3 are replaced by the one front leg 326C of FIG. 7. To provide adequate stability, front leg 326 is longer by about 30%, although this length disparity can be greater or less, depending upon the stability desired for a particular embodiment.

It is appreciated that various modifications may be implemented with respect to the above described embodiments. For example, embodiments contemplated herein can have various dimensions of length and width. In addition, some embodiments can have a base with four legs or a greater or lesser number of legs. Instead of the disclosed underarm cradle, some embodiments may have an accessory for clasping a user's forearm.

Obviously, many modifications and variations of the present invention are possible in light of the above teachings. It is therefore to be understood that within the scope of the appended claims, the invention may be practiced otherwise than as specifically described.

1. A crutch, or the like, that is enhanced and adapted to handle ground conditions, comprising:
an elongate brace having a lower extension and an upper element adapted to engage a portion of the human anatomy;
a device positioned at the lower extension, the device comprising a firm proximal member, and a firm distal member;
an elongate flexible structure adapted to engage the proximal member and the distal member, and allow them to angularly deflect relative to each other; and
a base positioned below the distal member and having multiple feet.

2. A crutch, or the like, according to claim 1 wherein the proximal member, and the distal member are positioned end-to-end, the distal member engaging the base, and the proximal member engaging the lower extension.

3. A crutch, or the like, according to claim 2 wherein the firm proximal member, and the firm distal member have a similar breadth.

4. A crutch, or the like, according to claim 3 wherein the firm proximal member, and the firm distal member are both tubular.

5. A crutch, or the like, according to claim 1 wherein the base comprises:
a plate having a plurality of angularly spaced, diverging legs, the multiple feet being attached distally to corresponding ones of the legs.

6. A crutch, or the like, according to claim 1 wherein the extension has an internal channel, the firm proximal member being sized to slide telescopically into the internal channel of the extension.

7. A crutch, or the like, according to claim 6 wherein the elongate flexible structure is a compressible component that is positioned to compress in response to the firm proximal member sliding into the internal channel of the extension.

8. A crutch, or the like, according to claim 7 wherein the compressible component abuts the extension and encircles the firm proximal member, the compressible component being positioned between the extension and the base.

9. A crutch, or the like, according to claim 5 wherein the plurality of angularly spaced, diverging legs comprise a front leg, a right leg, and a left leg, the front leg being longer than the right leg and the left leg.

10. A crutch, or the like, according to claim 7 wherein the firm proximal member and the firm distal member are tubular, the compressible component being slidably positioned inside the firm proximal member and the firm distal member, the compressible member having an upper end attached in the inside of the internal channel of the extension, the compressible member having a lower end attached to the base.

11. A crutch, or the like, according to claim 5 wherein the extension terminates in a flange, the compressible component comprising a helical spring engaging the flange.

12. A method for enhancing a crutch, or the like, that has a main body with an upper and a lower end, the method employing a firm proximal member and a firm distal member, the method comprising the steps of:
positioning the firm proximal member and the firm distal member below the upper end of the main body; and
allowing angular displacement between the firm proximal member and the firm distal member to produce an angular offset between the firm distal member and the main body.

13. A method according to claim 12 comprising the step of:
giving the firm proximal member and the firm distal member freedom to reciprocate toward positions that are in and out of alignment.

14. A method according to claim 13 employing a base and comprising the steps of:
positioning the base below the firm proximal member and the firm distal member; and
allowing the base to angularly displace in sympathy with angular displacement of the firm distal member.

15. A method according to claim 12, comprising the step of:
giving the firm distal member freedom to angularly reciprocate relative to the main body.

16. A method according to claim 12 comprising the step of:
biasing the firm distal member toward a direction that aligns it with the main body.

17. A method according to claim 12 comprising the step of:
giving the firm proximal member the freedom to axially reciprocate relative to the main body.

18. A method according to claim 13, employing an elongate flexible structure and comprising the steps of:
positioning the elongate flexible structure inside the firm proximal member and the firm distal member; and
giving the firm proximal member freedom to axially reciprocate relative to the main body.

19. A method according to claim 18 comprising the step of:
attaching the elongate flexible structure to the main body.
